(19) United States
(12) Patent Application Publication
(10) Pub. No.: US 2017/0064512 A1
(43) Pub. Date: Mar. 2, 2017

(54) SYSTEM AND METHOD FOR FACILITATING USER CONNECTIONS IN TRAVEL LOCATIONS

(71) Applicant: PERRY STREET SOFTWARE, INC., New York, NY (US)

(72) Inventors: Eric Silverberg, New York, NY (US); Jason Marchant, New York, NY (US)

(21) Appl. No.: 15/246,230

(22) Filed: Aug. 24, 2016

Related U.S. Application Data
(60) Provisional application No. 62/209,202, filed on Aug. 24, 2015.

(51) Int. Cl. H04W 4/02; H04L 29/08

(52) U.S. Cl. CPC H04W 4/025; H04L 67/306; H04L 67/18; H04L 67/1097; H04W 88/02

(57) ABSTRACT

A method for matching users of a social media platform traveling in the same location is disclosed. The method includes generating a travel database including a plurality of user travel data that corresponds to travel locations of a plurality of users, receiving new location information from a location module, the new location information corresponding to a current location of a user device, comparing the new location information to historical information to determine if the new location is a travel location. The method further includes that when the new location is a travel location, generating a user entry in a travel database, the travel database including user travel data corresponding to the user indicating travel to the current location, accessing the travel database to generate a user match notification corresponding to one or more other users traveling in the current location, and transmitting the user match notification to the user device.

### CROSS REFERENCE TO RELATED APPLICATIONS

The present application claims priority to U.S. provisional application No. 62/209,202 filed 24 Aug. 2015 entitled “System and Method for Facilitating User Connections in Travel Locations,” the disclosure of which is hereby incorporated by reference in its entirety.

### TECHNICAL FIELD

The present disclosure relates generally to computing devices, and more specifically, to facilitating user interactions and connections in travel locations.

### BACKGROUND

Users of social media, dating applications, dating websites, and community forums may use the selected platform to meet other users having similar preferences, activities, and so on. Currently these types of platforms allow users to search for other users based on location, user name, or a specific preference (e.g., college attended, occupation, height, hair color, age, etc.). The platforms that allow a user to search other users based on location typically determine location based on a user's inputted location or by automatically detecting a user's location, such as through a location sensor, such as a global positioning system (GPS). However, these platforms do not differentiate users that live near or around a location and those that are visiting the location. Thus, these platforms do not offer users an ability to connect with others that may be temporarily in a location, such as visiting a particular location, nor allow users to find a local user to assist in planning a trip to the location.

### SUMMARY

One example of the present disclosure includes a method for detecting user travel. The method includes receiving by the processing element a new location data corresponding to a location of a user device, comparing by the processing element the new location data to at least one historical location data to determine if the new location is a travel location, and when the new location is a travel location, storing a trip corresponding to the user indicating travel to the location.

Another example of the present disclosure includes a method for connecting users traveling to a location with other traveling users. The method includes receiving by a processing element a location selection from a first user, transmitting by the processing element at least one of the following to a first user device: visiting soon data, visiting now data, or ambassador data.

Another example of the disclosure includes a method for enrolling users as travel ambassadors for a travel platform. The method includes receiving a processing element an ambassador selection for a location from a user device, determining by the processing element whether the user corresponding to the user device is qualified to be an ambassador, if the user is qualified, transmitting by the processing element an ambassador agreement to the user device and upon receiving a consent to the ambassador agreement from the user device, assigning by the processing element the user to an ambassador role for the location.

In yet another example, a method for matching users of a social media platform traveling in the same location is disclosed. The method includes generating a travel database that includes a plurality of user travel data that corresponds to the travel locations of a plurality of users, receiving by the processing element new location information from a location module, the new location information corresponding to a current location of a first user device; comparing by the processing element the new location information to historical information to determine if the new location is a travel location; and when the new location is a travel location: generating by the processing element a first user entry in the travel database in a memory component, the first user entry including first user travel data that corresponds to the first user indicating travel to the current location; querying the travel database by the processing element to compare the first user travel data to one or more user travel data that corresponds to other users, generating a user match notification corresponding to one or more users traveling in the current location; and transmitting by the processing element the user match notification to the first user device.

In another example, a system for connecting social media users visiting a destination including a first user device corresponding to a first user account and a server. The first user device includes a first location module for determining location information, a first memory component for storing the location information, the location information includes new location data corresponding to current location of the first user device and historical data corresponding to two or more previous locations of the first user device, a first processor in communication with the first location module and the first memory component, a first display in communication with the first processor. The server is in communication with the first processor of the first user device and performs the following operations: receives new location data from the first processor; compares the new location data to historical location data to determine if the current location is a travel location; if the current location is a travel location, generates a first user travel entry in a travel database, wherein the first user travel entry comprises first user trip data; dynamically matches the first user travel entry with a second user travel entry having similar characteristics to the first user travel entry; and transmits second user information to the first display.

### BRIEF DESCRIPTION OF THE DRAWINGS

FIG. 1 is a diagram of a travel platform system.

FIG. 2 is a simplified block diagram of a computing device that may be used with the system of FIG. 1.

FIG. 3 is a flow chart illustrating a method for creating a trip itinerary.

FIG. 4 illustrates an example of a user interface for receiving a location selection by the user as displayed on a display of the user device.

FIG. 5 illustrates an example of a trip editor interface for use with the method of FIG. 3.

FIG. 6 is an example of a travelogue screen including upcoming trips for a user.

FIG. 7 is a flow chart illustrating an example of a method for automatically creating trip itineraries for a user.

FIG. 8 is a flow chart illustrating a method for connecting traveling users to others.

FIG. 9 is an example of a location screen for a particular location.

FIG. 10 is an example of a visiting now screen that may be transmitted as part of the visiting now data.

FIG. 11 is an example of a combination screen including visiting now data and ambassador data.

FIG. 12 is a flow chart illustrating a method for selecting ambassadors for a particular location.

FIG. 13 illustrates a screen shot of an ambassador selection page.

FIG. 14 illustrates an example of an ambassador agreement screen.

FIG. 15 illustrates an example list of ambassadors for a location.

FIG. 16 illustrates an example of a block diagram for a travel platform 100 for implementing the methods of FIGS. 3, 7, 8, and 12.

### SPECIFICATION

In some embodiments herein, a system and method for allowing users to connect with users visiting the same locations, as well as connect users to local users that live in a destination location. The system and method defines a platform that automatically detects and stores travel data that is used to dynamically couple travelers with other travelers or users in a destination. The travel platform allows users to create trip itineraries for travel to a location and/or automatically detect a user's location and create a trip itinerary. Based on a user's location and/or a trip itinerary the travel platform provides local user details (e.g., user name, contact information, etc.) to allow a visiting user to communicate with a local user to answer questions about the location (e.g., best hotels, good restaurants, fun bars). Additionally, the travel platform provides traveling user details about visiting users, thus allowing the user to connect with others that are visiting a location, providing a user the ability to invite others to landmarks and tourist destinations so that a user does not have to visit these areas alone or with their travel companions. The travel platform also allows a visiting user to connect with users who are traveling to the location at the same time as the visiting user, but before the trip has begun. This allows a visiting user to plan in advance to meet up with other traveling users.

Conventional social networking platforms do not store user travel information, nor provide a way for users to automatically connect if they are in a new travel location. In particular, conventional platforms require users to search individually for user data, such as user posted updates, in order to determine whether a particular user may be traveling in a similar location. This type of individual search, requires intensive user input and time, as well as can generate erroneous result lists since not all users may update their status or provide updates as to travel. Using the platform of the present disclosure, travel data is automatically detected and stored in a travel database and users are matched dynamically, omitting errors and eliminating the need for users to search individually for users that may be traveling to the same location. Given the large number of users on typical social networking sites, this enhances the efficiency of the travel process and allows users to connect in ways not previously offered or available from conventional platforms, while eliminating the tedious searching required.

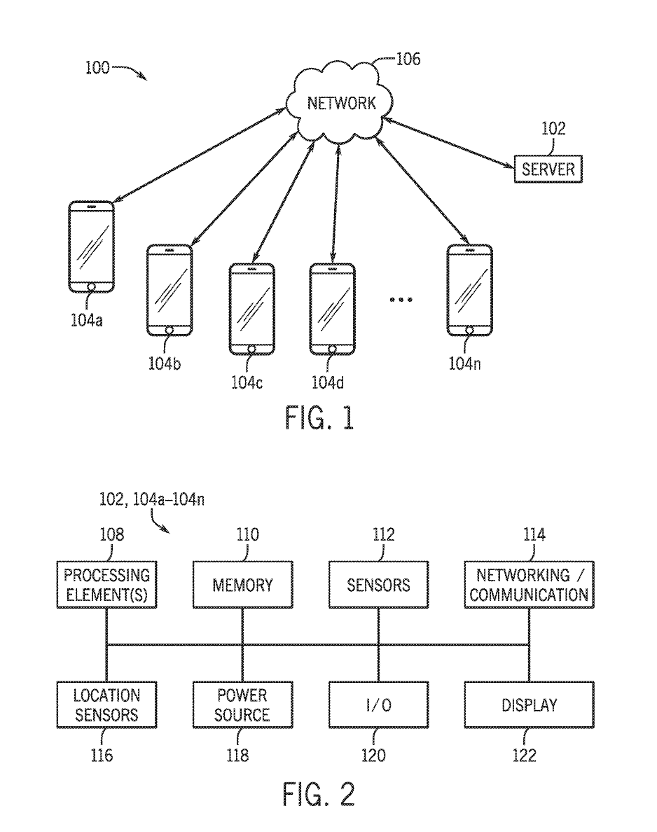

Turning now to the figures, a travel platform for assisting travelers will now be discussed in more detail. FIG. 1 is a travel platform system 100 including a server 102 and a plurality of user devices 104a-104n in communication with one another and the server 102 via a network 106, each of the components will be discussed in turn below.

The server 102 may be substantially any type of computing device but typically may be one or more computing devices in communication with one another that perform one or more tasks for the user devices 104a-104n. In some embodiments, the server 102 may be a computing device that hosts a web server application or other software application that transmits and receives data to and from the user devices 104a-104n. The server 102 may typically include one or more processing elements, memory components, and networking/communication interfaces, but may generally have a larger processing power and memory storage as compared to the client or user devices 104a-104n. The server 102 is configured to host one or more aspects of the travel platform as discussed herein. The server 102 hosts a travel information database that stores travel data corresponding to the user devices 104a-104n which can then be used to dynamically match users based on trip information. As noted below, the type of travel data stored in the database eliminates the need for laborious searching and is not stored in conventional social networking platforms.

The user devices 104a-104n may also be substantially any type of computing device. Some non-limiting examples include a smartphone, a tablet computer, a digital music player, portable gaming station, laptop computer, set top box, media player (e.g., digital video disc player, digital video recorder), or the like. In many embodiments the user devices 104a-104n are portable computing devices with an integrated display, such as a smart phone. It should be noted that in many embodiments, the platform 100 may include a querying user device and responsive or member user devices.

FIG. 2 is a simplified block diagram of a computing device. With reference to FIGS. 1 and 2, the user devices 104a-104n and/or server 102 may include one or more of the components shown in FIG. 2 such as one or more processing elements 108, one or more memory components 110, one or more sensors 112, a networking/communication interface 114, a location sensor 116, a power source 118, an input/output interface 120, and/or a display 112. It should be noted that FIG. 2 is meant as exemplary only, in other examples the computing devices of the system, e.g., the server 102 and user devices 104a-104n, may include fewer or more components than those shown in FIG. 2.

The one or more processing elements 108 may be substantially any electronic device capable of processing, receiving, and/or transmitting instructions. For example, the processing element 108 may be a microprocessor, processor, or a microcomputer. Additionally, it should be noted that the processing element 108 may include more than one processing member. For example, a first processing element may control a first set of components of the computing device and a second processing element may control a second set of components of the computing device where the first and second processing elements may or may not be in communication with each other. Additionally, each processing element 108 may be configured to execute one or more instructions in parallel.

The memory 110 stores electronic data that may be utilized by the computing devices 102, 104a-104n. For example, the memory 110 may store electrical data or content e.g., audio files, video files, document files, and so on, corresponding to various applications. The memory 110 may be, for example, non-volatile storage, a magnetic storage medium, optical storage medium, magneto-optical storage medium, read only memory, random access memory, erasable programmable memory, flash memory, or a combination of one or more types of memory components. In many embodiments, the server 102 may have a larger memory capacity than the user devices 104a-140n. The memory 110 may be configured to access one or more databases, such as travel information databases, that may be generated or created by the processor during the various methods described below.

The sensors 112 may provide substantially any type of input to the computing devices 102, 104a-104n. For example, the sensors 112 may be one or more accelerometers, microphones, global positioning sensors, gyroscopes, light sensors, image sensors (such as a camera), force sensors, and so on. The type, number, and location of the sensors 112 may be varied as desired and may depend on the desired functions of the system 100.

The networking/communication interface 114 receives and transmits data to and from the network 106 to each of the computing devices 102, 104a-104n. The networking/communication interface 114 may transmit and send data to the network 106, and/or other computing devices. For example, the networking/communication interface may transmit data to and from other computing devices through the network 106 which may be a cellular or other wireless network (e.g., WiFi, Bluetooth) or a wired network (e.g., Ethernet), or a combination thereof.

The location sensors 116 or location module provides location information, such as GPS data, for the computing devices. In some embodiments the location sensors 116 may include a GPS receiver or other sensors that track the strength and other characteristics of a signal, such as a cellular signal, to determine a location for the computing device. In embodiments including a GPS receiver, the location sensors 116 may receive data from three or more GPS satellites and then may use the satellite information to determine a location of the device. The location sensors 116 may be configured to determine latitude and longitude information for the computing device, e.g., the user devices 104a-104n. It should be noted that in many embodiments the location sensors 116 may use a combination of GPS satellite data and data from other sources, such as WiFi and/or cellular towers. The accuracy, format, and/or preciseness of the latitude and longitude (or other location data from the location sensors 116) may vary based on the type of computing device and the type of location sensors 116.

As will be discussed in more detail below, the latitude and longitude, city, neighborhood, zipcode, or other location data may be transmitted from the user devices 104a-104n to the sever 102. The server 102 in some instances may store the location of each of the user devices 104a-104n in an uniform resource locator (URL) or other web address that may be accessible by the server 102 and other computing devices granted access. For example, the server 102 may include a URL endpoints list that includes the location data for a plurality of the user devices 104a-104n in communication with the server 102, this will be discussed in more detail below. Additionally, as discussed in more detail below, the server 102 may include databases storing location information, such as city boundaries, city shape files corresponding to boundaries of a city, and the like, and this location information can be used along with the data from the user devices to determine a location of the user.

The computing devices 102, 104a-104n may also include a power supply 118. The power supply 118 provides power to various components of the computing devices 102, 104a-104n. The power supply 118 may include one or more rechargeable, disposable, or hardwire sources, e.g., batteries, power cord, or the like. Additionally, the power supply 118 may include one or more types of connectors or components that provide different types of power to the computing devices 102, 104a-104n. In some embodiments, the power supply 118 may include a connector (such as a universal serial bus) that provides power to the computer or batteries within the computer and also transmits data to and from the controller 104 to the machine 102 and/or another computing device.

The input/output interface 120 allows the computing devices 102, 104a-104n to receive inputs from a user and provide output to the user. For example, the input/output interface 120 may include a capacitive touch screen, keyboard, mouse, stylus, or the like. The type of devices that interact via the input/output interface 120 may be varied as desired.

The display 122 provides a visual output for the computing devices 102, 104a-104n. The display 122 may be substantially any size and may be positioned substantially anywhere on the computing devices 102, 104a-104n. For example, if the server 102 includes a screen, the display will typically be a separate component from the server 102 and in communication therewith, whereas the user devices 104a-104n may include an integrated display screen. In some embodiments, the display 122 may be a liquid crystal display screen, plasma screen, light emitting diode screen, and so on. In some embodiments, the display 122 may also function as an input device in addition to displaying output from computing device. For example, the display 122 may include capacitive touch sensors, infrared touch sensors, or the like that may capture a user's input to the display 122. In these embodiments, a user may press on the display 122 in order to provide input to the computer device. In other embodiments, the display 122 may be separate from or otherwise external to the electronic device, but may be in communication therewith to provide a visual output for the electronic device.

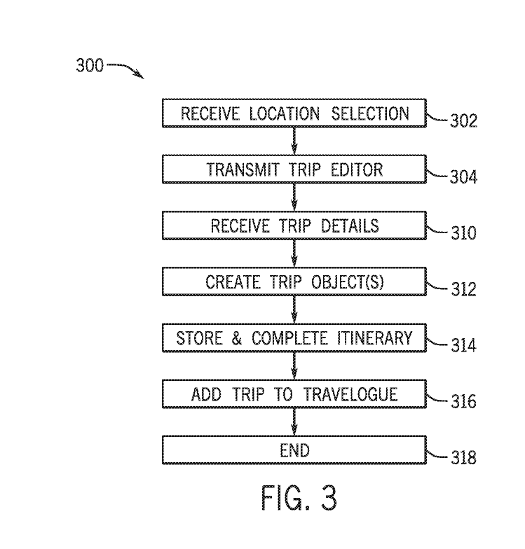

A method for allowing a user to create a trip itinerary using the platform 100 of FIG. 1 will now be discussed. FIG. 3 is a flow chart illustrating a method for creating a trip itinerary. With reference to FIG. 3, the method 300 may begin with operation 302 and the server 102 receives a location selection from a user device 104a. The location selection 104a may be input by the user, such as via selection of a location icon (e.g., city graphic or name) or inputting the location name directly. The location may be a city, country, state, neighborhood, zip code, congressional district, metro area, latitude and longitude, or the like. Additionally, a location may correspond to multiple location entries, e.g., the LoDo neighborhood of Denver, Colo. can correspond to a selection of the city of Denver, the state of Colorado, the LoDo neighborhood, and the 80202 zip code. As explained below, during the trip itinerary operation, the server may pull external information from one or more first or third party databases. This external data may be pulled based on the user location and provides additional city information that may be useful to the user, as well as helps to generate the user location and determine whether the user is in a particular city.

In one embodiment, the locations may be defined according to the following example:

CREATE TABLE \grave{ }locations\grave{ } (
\grave{ }id\grave{ } int(11) NOT NULL AUTO_INCREMENT,
\grave{ }geocell\grave{ } varchar(255) NOT NULL,
\grave{ }name\grave{ } varchar(255) NOT NULL,
\grave{ }iso2_country_code\grave{ } varchar(255) DEFAULT NULL,
\grave{ }state\grave{ } varchar(255) DEFAULT NULL,
\grave{ }location_type\grave{ } int(11) DEFAULT NULL,
\grave{ }country\grave{ } varchar(2) DEFAULT NULL,
\grave{ }latitude\grave{ } float DEFAULT NULL,
\grave{ }longitude\grave{ } float DEFAULT NULL,
\grave{ }distance_from_center\grave{ } float DEFAULT NULL,
\grave{ }has_travel_advisory\grave{ } int(11) NOT NULL DEFAULT ′0′,
\grave{ }geo_city_id\grave{ } int(11) DEFAULT NULL,
\grave{ }has_image\grave{ } tinyint(1) NOT NULL DEFAULT ′0′,
\grave{ }version\grave{ } int(11) DEFAULT NULL,
\grave{ }i18n_key\grave{ } varchar(255) DEFAULT NULL,
PRIMARY KEY (\grave{ }id\grave{ }),
ENGINE=InnoDB DEFAULT CHARSET=utf8;

Using the above example, travel information may be generated in a table or other format in the memory that the processor or server can access later to connect various users that are traveling to the same or similar locations. In the above example, the distance from center may be used to quickly determine whether the location of the user device 104 is within a city boundary. For example, the distance from center calculation may determine a radius from a center of a city based on latitude and longitude. The radius may be used to draw an arbitrary or geometric shape, such as a circle, around the center point and the location of a user is analyzed to determine if it falls within the arbitrary shape, and if so it is determined that the user is traveling within the city. In some instances this calculation may be not exactly track city boundaries as many cities do not have perfectly geometric boundaries. Accordingly, in some instances, the user's location may be compared to a pre-stored city shape file stored on the server where the shape file is set from a center point or otherwise able to be overlaid on a latitude/longitude location. In these examples, the city determination of the user may be more accurate as it accounts for the specific shape of a city boundary.

Other travel information determined with the above example includes determining whether the city has a travel advisory or is a geo city. In these examples, the server may pull data from first and/or third party databases bases on the location of the user. With travel advisories, the server may determine whether the user is in a city that may have travel advisories, e.g., security, hostility to certain people, weather advisories, or the like. In one embodiment, the travel advisories may be stored on a first party database and dynamically generated based on security information and other data. The geo city information may pull from databases that include information about certain cities around the world, the information may correspond to city facts (e.g., population, elevation, language spoken, etc.), as well as include translation information for the city name. In embodiments where the city name and language may be different from a user device language (or user language as set in a preference on the device), the server may use the geo city or other third party database data to translate the city name into the language of the user. This may be especially useful for alphabet based language speaking users traveling to character based language locations and vice versa.

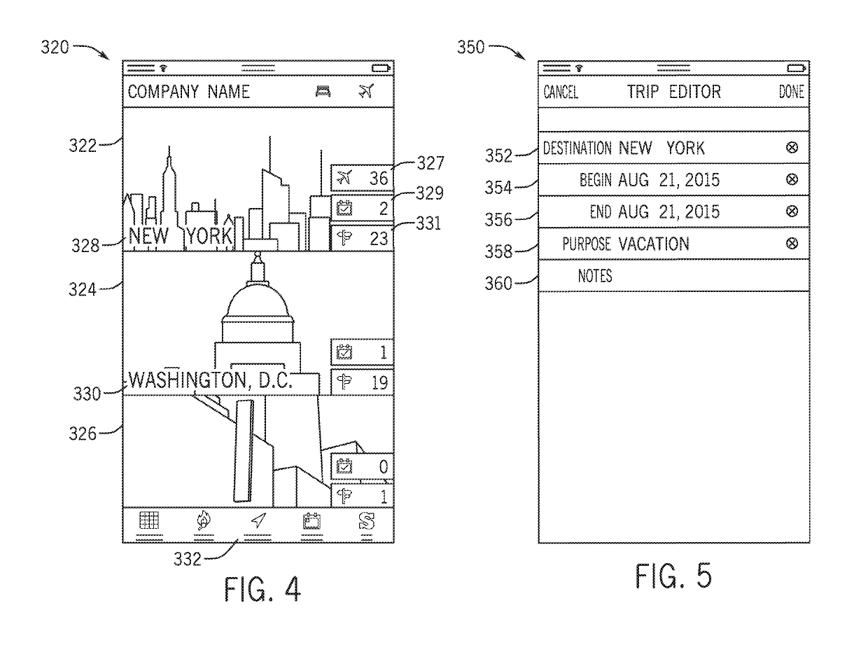

FIG. 4 illustrates an example of a user interface for receiving a location selection by the user as displayed on a display of the user device 104a. With reference to FIG. 4, in one embodiment the travel platform 100 displays a location selection screen 320 that includes selectable images, graphics, or the like. In one example, there are three selectable images 322, 324, 326 displayed that include a city name 328, 30, 332 either typed over a city graphic (e.g., names 328, 330) or integrated into the graphic (e.g., city name 332). The display of the city selectable image may be varied as desired and the screen shot 320 shown in FIG. 4 is meant as exemplary only. Using the location selection screen 320 of FIG. 4, the user selects one of the listed locations 328, 330, 324, 326 by selecting the image. The images may be pulled from a location database in communication with the server and the travel platform 100 and the city name may be translated to the user device language before display, depending on the user device language, city official language, and/or user preferences.

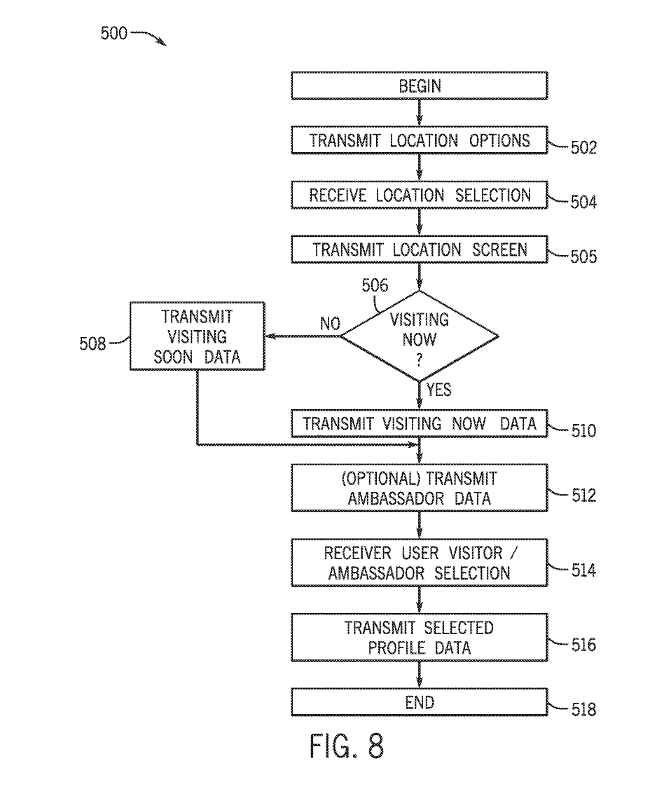

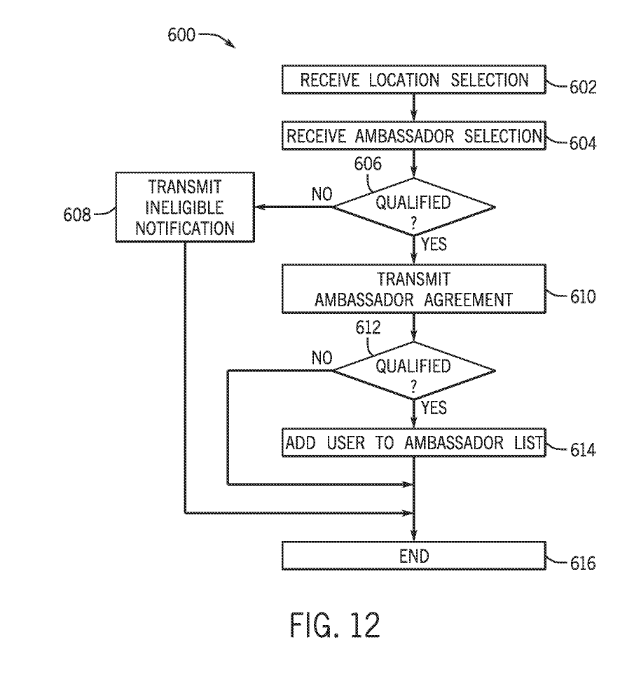

With reference to FIG. 4, in some embodiments, the location selection screen 320 may include destination or travel information. For example, the location selection screen 320 may include traveler number information 327, which may be represented as a first icon on a right hand of the screen adjacent a number. The traveler number information 327 includes information corresponding to the number of travelers traveling at the same time as the user or may include information corresponding to the number of travelers currently at that location. The location selection screen 320 may also include event information 329 and ambassador information 331, which similar to the traveler number information 327, may include descriptive icons adjacent a number corresponding to the number of events or ambassadors. The event information 329 may include information corresponding to the number of events occurring in the city at the user's travel information, the number of events in the upcoming days, and/or the number of events that the user has followed or RSVP′d to go. The ambassador information 331 may correspond to the number of ambassadress (as determined in FIGS. 8 and 12) for a particular location. In some embodiments, the travel information icons 327, 329, 331 may be selectable by a user to lead to additional information for each of the categories.

It should be noted that in some embodiments, the travel platform 100 may limit the number the number of locations where travel assistance and trip planning are provided. For example, the travel platform 100 may be integrated into one or more other dating or social media platforms, such as, SCRUFF, and the number of locations may be predetermined. In these instances, if a user inputs a city that is not currently selected as a travel location, a notification may be displayed letting the user know that the location is not yet an explorer city.

With reference again to FIG. 3, after the server 102 has received the location selection, the method 300 proceeds to operation 304. In operation 304, the server 102 transmits the trip editor interface to the user device 104a. FIG. 5 illustrates an example of the trip editor interface 350. With reference to FIG. 5, the trip editor interface 350 includes multiple data entry fields, for example, a destination field 352, a begin field 354, an end field 356, a purpose field 358, and optionally a notes field 360. The user may then input or select from a drop down menu, calendar, or other input mechanism the information to complete each of the fields 352, 354, 356, 358 and may input notes if desired into the notes field 360. In the example shown in FIG. 5, the user entered New York as the location in the destination field 352, with a trip start date of Aug. 21, 2015 entered into the begin field, a trip end date of Aug. 21, 2015 in the trip end field 356, and vacation entered in the purpose field 358. The user has not entered any notes in the notes field 360.

One or more of the fields may be stored in a predetermined format to allow the processing element of the server 102 to format and access the information in a predetermined manner. For example, in one embodiment, the trip itinerary may be stored as a first-class object with a table with each of the readable fields 352, 354, 356, 358 stored in the table. In this example, the completed trip itinerary may be stored as follows:

CREATE TABLE \grave{ }trips\grave{ } (
\grave{ }id\grave{ } int(11) NOT NULL AUTO_INCREMENT,
\grave{ }profile_id\grave{ } int(11) NOT NULL,
\grave{ }starts_at\grave{ } date DEFAULT NULL,
\grave{ }ends_at\grave{ } date DEFAULT NULL,
\grave{ }notes\grave{ } text,
\grave{ }category\grave{ } int(11) DEFAULT NULL,
\grave{ }location_id\grave{ } int(11) NOT NULL,
\grave{ }ongoing\grave{ } tinyint(1) NOT NULL DEFAULT ′0′,
\grave{ }server_created\grave{ } tinyint(1) NOT NULL DEFAULT ′0′,
\grave{ }created_at\grave{ } datetime NOT NULL,
\grave{ }updated_at\grave{ } datetime NOT NULL,
PRIMARY KEY (\grave{ }id\grave{ }),) ENGINE=InnoDB DEFAULT
CHARSET=utf8mb4;

It should be noted that one or more of the fields 352, 354, 356, 358 may not have to be completed by the user in order for an itinerary to be created. For example, the user may choose to not select an end date and leave the end field 356 incomplete or empty, in this example, the trip may be selected as on-going for the itinerary. The fields in the trip itinerary can be used by the server to match a user with other visiting users or local ambassador users, as will be discussed below. For example, if the purpose of the trip is vacation rather than another entry (e.g., work/business, family), the user may be matched with other tourist visitors as compared to other business users if a work related purpose is selected.

In some embodiments, the trip editor interface may be stored on the user device 104a, rather than be transmitted to the server 102 and the data in the completed trip editor interface may be transmitted to the server 102 after it has been completed by the user.

With reference again to FIG. 3, once the user has completed entry of the travel details on the trip itinerary screen 350 the method 300 proceeds to operation 310. In operation 310, the completed itinerary is transmitted to the server 102. Then, as briefly mentioned above, the method 300 may proceed to operation 312 and one or more trip objects are created by the server 102 and then the method 300 proceeds to operation 314 and the complete itinerary is stored in memory of the server 102. It should be noted that operations 312 and 314 may be reversed and/or completed as a single operation.

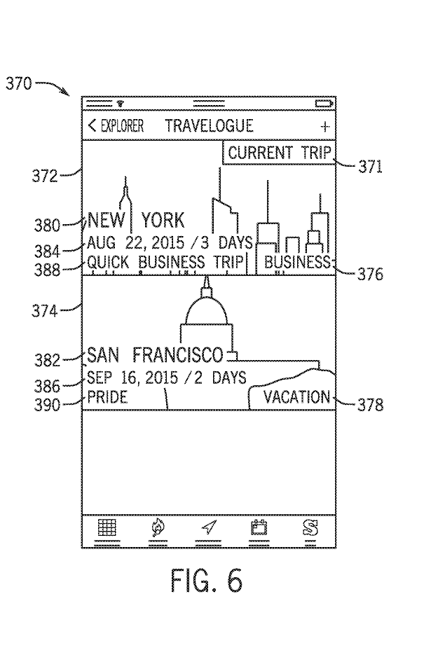

With reference to FIG. 3, after operation 314, the method 300 may proceed to operation 316. In operation 316 the trip is added to a “travelogue” for the user and stored with the user's profile information. The additional trip data, such as travel advisories, location name, etc. that may be pulled from external databases may be saved as well or otherwise able to be displayed with the user's trip information. This allows the user to view his or her upcoming trips and associated information. FIG. 6 is an example of a travelogue screen 370 for a user. With reference to FIG. 6, in this example, the user has two trips upcoming, a first trip 372 to New York and a second trip 374 to San Francisco. In the travelogue screen 370 details of the user's trip itinerary (e.g., those corresponding to the fields completed by the user on the trip itinerary screen 350) are visible and optionally may be in a modified form. For example, with reference to the first trip 372, the destination field is shown in a large text “New York” and the begin date of Aug. 22, 2015 is shown, along with the purpose selected 376 “business” and any notes 384 input by the user, in this case “Quick business trip.” In some embodiments, the travelogue screen 370 may also include a status indicator 371 that indicates that the trip is a current trip. The status indicator 371 may be displayed on for the current trip or may include “upcoming trip” or “next trip” for those trips that are not currently on-going.

As noted some of the readable fields may be modified and in this example, the end date is not displayed, but rather the server computes the duration of the trip and displays the duration information along with the begin date, rather than the end date. However, in other embodiments all of the data may be displayed in a similar manner or other types of data may be modified as desired.

Similarly, with continued reference to FIG. 6, for the second trip 374, the destination 382 is displayed along with the begin date 386, the duration, the notes 390 “Pride,” and the purpose 378 “vacation.” With reference again to FIG. 3, after operation 316, the method 300 may proceed to an end state 318.

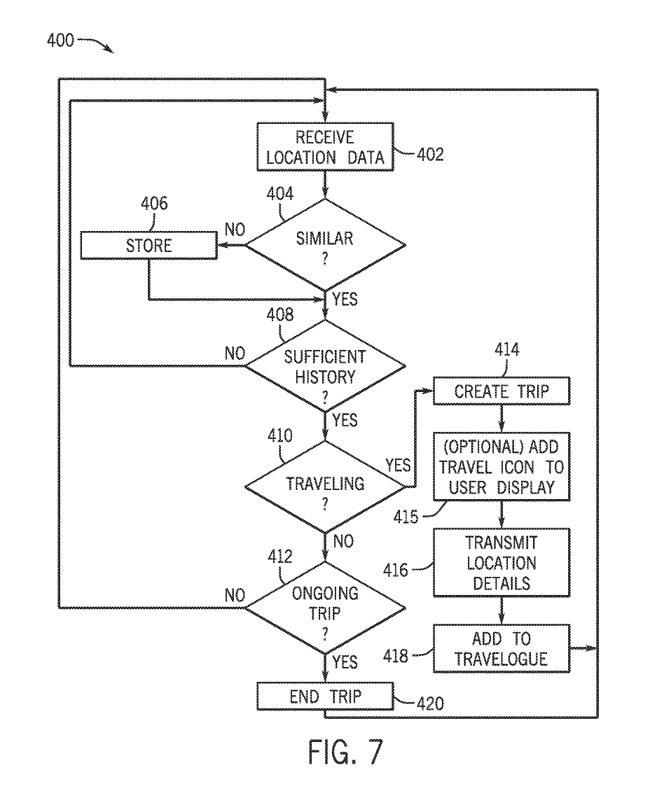

In some embodiments the travel platform 100 may automatically create trip itineraries for a user. FIG. 7 is a flow chart illustrating an example of a method for automatically creating trip itineraries for a user. With reference to FIG. 7, the method 400 may begin with operation 402. In operation 402, the server 102 receives a user device 104a location data, e.g., latitude and longitude, GPS coordinate, WiFi network, or other location determining technology provided by the user device 104a and/or operating system. The location data may be transmitted from the one or more location sensors 116 of the user device 104a and may be transmitted to the server 102 at predetermined intervals, e.g., every 10 minutes, when the user launches a particular application, activates his or her device, or the like.

After operation 402, the method 400 proceeds to operation 404. In operation 404 the server 102 determines whether the location is similar to a previous measurement. For example, a location that is identical to close to the most recent measurement is considered to be similar to the previous measurement unless a minimum time period has passed. That is, in this example, if a user's location is the same as or within a predetermined radius, geographical area, or other perimeter from the last received location within a predetermined time period or as compared to the last location saved, the location is determined to be similar to the previous location. However, even in instances where the location may be identical to the previous location (e.g., a user's home location), if the measurement is sufficiently far apart in time from the previous reading, the location may be determined to not be similar for the purposes of method 400. If the location is not similar, i.e., is a new location, the method 400 may proceed to operation 406 and the server 102 stores the location data in a database. However, if in operation 404 the location is similar, the method 400 proceeds to operation 408 and uses the previously stored location for the remaining operations.

After operation 406 or in instances where the location is the same or similar to the previous location in operation 404, the method 400 proceeds to operation 408. In operation 408, the server 102 determines whether there is sufficient history to determine whether the user is traveling. For example, before the system 100 may detect travel, the server 102 may store a predetermined number of historical locations, e.g., 50 location measurements, and use the historical data to determine if the user is traveling by comparing these measurements to a known “home” area or location or assessing the change between the various measurements. If in operation 408 there is not sufficient historical data, the method 400 may return to operation 402 and continue to receive user location data, which may be at the predetermined intervals or other preset time. If the number of previously stored location data points matches the historical threshold, the method 400 may proceed to operation 410.

In operation 410, the server 102 determines whether a user is traveling by comparing the most recent location data or information to the historical data or information. For example, the server 102 may take a subset of the user location history, e.g., the last 50 measurements, and compute the median latitude and median longitude for those 50 measurements. Then, the server 102 measures the distance of the latest location to the median location. If this distance exceeds a predetermined threshold, e.g., 100 km, the server 102 determines that the user is traveling. Other methods may be used to assess whether a user is traveling. For example, the server 102 may compare the two most recent locations alone to determine whether the new location exceeds a predetermined distance threshold. As another example, the user may set a “home” area and the location point may be compared to the home area and when the location point exceeds a predetermined threshold from the home area the server 102 may determine that the user is traveling. In some embodiments, the user location may be compared to one or more known city locations, such as by the latitude or longitude, as well by the city shape or boundaries discussed above.

With reference to FIG. 7, if the server 102 determines that the user is traveling, the method 400 proceeds to operation 414. In operation 414 the server 102 creates a trip for the user, where the trip may be defined by the location of the user device being outside a predetermined home area and/or within a known geographic area of an existing city or region. In some embodiments, a trip may not be created in instances where the user may fall within a predetermined range from a home location or in instances where the user may be outside the predetermined range but near or in a very small town. In other words, in some embodiments, the platform 100 may have thresholds for “cities” in order to limit the trip itineraries to larger cities or known destinations. This helps to prevent the platform 100 from overly generating trip itineraries for destinations that may be temporary or that may not have large numbers of users living or traveling to the location. In embodiments where the server is creating the trip, the server 102 automatically completes a trip itinerary for the user and selects the current location as the location destination, the begin date of the trip as the date of the most recent location measurement, and the end date as open. The “purpose” field of the trip itinerary is left incomplete.

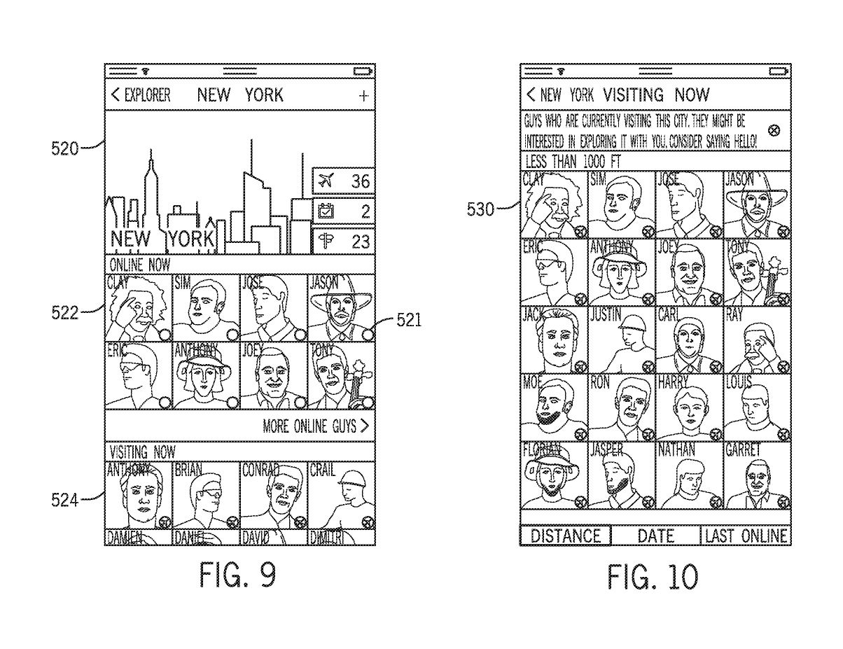

In some embodiments, after or as the trip is being created in operation 414, the method 400 may proceed to operation 415 and the server may add a travel icon to the user's display. This travel icon may be displayed on the user's profile and when the user's information is displayed on other user devices. For example, as shown in FIG. 9, a traveling now icon 521 may be displayed over the user's picture and may include a plane or other descriptive graphic to indicate that the user is currently traveling. A similar type of graphic may be displayed on the user's own profile screen or the like. The traveling now icon 521 helps to alert other users that the select users are online and traveling in the current location at the same time as the user.

After operation 415, the method 400 proceeds to operation 416 and the server 102 transmits the trip itinerary to the user device 104a and then the method 400 proceeds to operation 418 and the server 102 adds the trip to the travelogue of the user. After operation 418, the method 400 may return to operation 402 and continue to receive location data from the user device 104a. The trip itinerary includes the travel data of the user and is stored in a travel database indicating that the user is traveling to the travel location.

If in operation 410, the server 102 determines that the user is not traveling, the method 400 proceeds to operation 412. In operation 412 the server 102 determines whether there is an on-going trip, i.e., whether the user was previously identified as traveling. If the user was not previously identified as traveling, the method 400 returns to operation 402. However, if the user was previously identified as traveling, the method 400 proceeds to operation 420. In operation 420, the server 102 ends the “ongoing” trip in the travelogue and trip itinerary and the user 104 is no longer listed as traveling. After operation 420, the method 400 may return to operation 402 and continue to receive location data at the predetermined times.

Using the method 400 of FIG. 7, the system 100 can automatically detect when a user is traveling and use this information to create trip itineraries and store travel information in the memory. This allows a user to access the various features of the platform and allows him or her to connect with other travelers, local ambassadors, and the like, without having to create a trip itinerary. This feature may be especially helpful in the beginning activation of the platform 100 when users of the social media or dating application may not be aware of the traveling features and by automatically enrolling a user in a trip and providing access to these travel features a user can be introduced to these features without much or any effort.

As mentioned above, the travel platform 100 connects users who are traveling or who may be traveling to other traveling users and/or local ambassadors (e.g., local users in the traveling location). FIG. 8 is a flow chart illustrating a method 500 for connecting traveling users to others. With reference to FIG. 8, the method 500 may begin with operation 502 and the server 102 transmits the location selection screen 320 of FIG. 4 to the user device 104a. After transmission of the location selection screen 320 of FIG. 4, the method 500 proceeds to operation 504 and receives a user's selection of a location. Alternatively, the server 102 may use the trip itinerary created in one of methods 300, 400 of FIGS. 3 and 7 to determine the location selection of the user (i.e., the traveling location of the user) and in these embodiments, the location selection may be done automatically by referencing the data stored in the travel information database.

After operation 504, the method 500 may proceed to operation 505 and transmit the location screen 505. FIG. 9 is an example of a location screen 520 for a particular location. With reference to FIG. 9, the location screen 520 may include the location information (e.g., city name, graphic, etc.), as well as users or members that are currently visiting the city “visiting users” 524, users that live in the city that are online at the current time “online users” 522, as well as members that are visiting the city in the near future. The user location information may be determined by comparing the travel database to search for users having travel data matching, at least in part, the user's travel data stored in the travel database, e.g., traveling to the same city, traveling for the same purpose, or the like. In this manner, the method 500 may provide a user match notification, such as a list of members visiting the city, as well as other travel information, without requiring the user to individually screen each user or generate a search query, as the results are generated automatically, by referencing the travel information databases. For example, the server queries the database to compare travel information of a select user with the travel entries of other users.

After operation 505, the method 500 may determine whether the user is visiting now or selects to view more visiting users 524. For example, the server 102 may determine in the method 400 of FIG. 7 that the user is already in the traveling location. As another example, the sever 102 may determine using the trip itinerary that the user is in the traveling location. If it is determined that the user is traveling now or the user selects to view users that are traveling now, the method 500 proceeds to operation 510 and the server 102 transmits the visiting now data. In this operation, the processing element or server may query the travel information database to compare the travel location with the travel locations of other users to determine which users are traveling in the location at the selected time and then generate a user match notification that corresponds to the “matched” users.

FIG. 10 is an example of a visiting now screen 530 that may be transmitted as part of the visiting now data and match notifications regarding other users traveling in that location. As shown in FIG. 10, the visiting now screen 530 may include a grid or other type of display of users (e.g., profile pictures, names, and/or other identifying information) that are traveling in the location at the same time as the user. The users in the visiting now screen 530 may be displayed in an order of distance, e.g., those users that are closest to the user may be displayed first. In some embodiments the users that are displayed may be filtered by the purpose field of the user's trip itinerary. For example, only other users that are visiting or will be visiting for vacation may be displayed to a user who is on vacation. As another example, only users that will be visiting or are visiting for business may be displayed to a user who is visiting a location for business.

With reference again to FIG. 8, if the user is not traveling at the moment, i.e., is traveling at some point in the future or selects to display users that are traveling in the future, the method 500 proceeds to operation 508. In operation 508, the server 102 transmit the visiting soon data, which includes a visiting soon page that may be similar to the visiting now screen 530 but include users that are traveling in the future. In some embodiments, the visiting soon screen may include users that are traveling at the same time as the user. For example, the server 102 may use the trip itinerary to assess the travel dates of the user and filter the visiting soon users to display only those users. In other embodiments, the server 102 may also include users that have recently visited the city, which may assist users that are visiting soon in planning their trips.

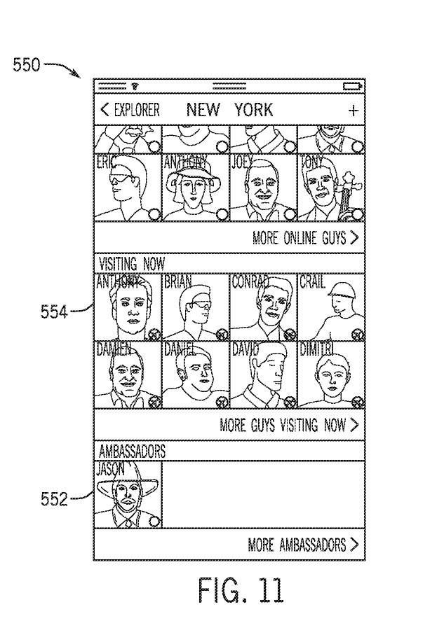

After operations 508 or 510, the method 500 proceeds to operation 512. In operation 512, the server 102 may transmit ambassador data. The ambassador data may be transmitted simultaneously with the visiting now or visiting soon data or may be transmitted separately from the visiting now or visiting soon data. For example, with reference to FIG. 11, a combination screen including visiting now data and ambassador data is shown. In the combination screen 550, the visiting now users 554 and the ambassador users 552 are each displayed in separate categories in a grid, although other display options can be used as well. The location of the users in the grid may be varied as desired but may be arranged by distance relative to the user, travel dates, helpfulness or other assess characteristic, or the like.

With reference again to FIG. 8, after operation 512, the method 500 may proceed to operation 514 and the server 102 may receive the user's visitor and/or ambassador selection. For example, the user may select one of the user's icons on the combination page 550, visiting now screen 530, or the like. After the user has selected a particular user, the method 500 proceeds to operation 516 and the server 102 transmits the selected or matched user's profile data or other additional information to the user. For example, the selected user's contact information, user name, profile picture, or hotel may be transmitted to the user's device 104a to allow the user to contact the selected user or ambassador. In these examples, the platform 100 may utilize the typical communication pathways of a parent application. For example, the platform 100 may be integrated into an existing system or application, such as a dating or meet-up application and once the users have been connected, may use the predetermined communication mechanism to allow the users to communicate. After operation 516, the method 500 may proceed to an end state 518.

Using the method 500 of FIG. 8, users that are visiting now can connect with users that are visiting a location at the same time as themselves by providing user information to the two or more user devices that are traveling. This allows a user to arrange for a companion or group of people to do tourist activities, such as sightsee, tours, as well as have company for dinners, drinks, and the like, in the city or location. Current social media and dating websites and applications do not offer users an ability to connect with other users that are traveling in the same city and may want to visit a particular tourist area in the same time frame. Conventional platforms also require users to manually enter in search information that may be relevant to a particular destination in order to filter users that may be tourists or traveling at a similar time. The method of FIG. 8 automatically generates a travel information database storing various user travel information, including location, visit type, etc., and this database is referenced to dynamically generate matches between traveling users and send the relevant information to each of the matched user devices.

Additionally the method 500 of FIG. 8 allows users to connect with users that are visiting soon, which allows users to coordinate trips with other users and can allow users to organize sightseeing tours, split hotel room fees, or the like. Additionally, because the travel platform 100 may be integrated into an existing user network, the travel platform can act as a first filter to allow a user to filter a user list to view only those users that are currently traveling and then the user can apply the overall platform's filters (e.g., age, preferences, activities, or the like) to further filter the list of members. This allows a user to view not only those users that are traveling, but further refine the list to display only those users that he or she may want to connect with. This type of filtering can be done more accurately and quickly by accessing the travel information database, rather than requiring a separate search of user statuses, posted information, or the like as is conventionally done.

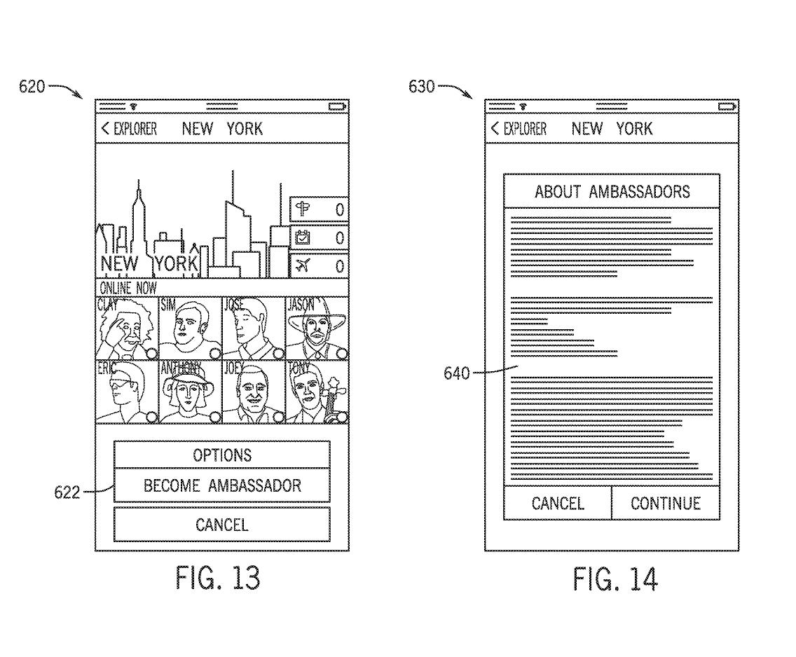

As mentioned above, another feature of the travel platform 100 is that it provides users with a connection to local ambassadors or users that live or are familiar with a particular traveling location. FIG. 12 is a flow chart illustrating a method 600 for selecting ambassadors for a particular location. With reference to FIG. 12, the method 600 may begin with operation 602 and the server 102 may receive a location selection. The location selection may be input by a user, e.g., by typing in a city name or selecting a location graphic or icon, or may be determined automatically, e.g., by assessing a user's most frequent location or a user's home location. If a user's selection is for a city that the user lives in, the server 102 may display an ambassador selection page. FIG. 13 illustrates a screen shot of an ambassador selection page 620. As shown in FIG. 13, the ambassador selection page 620 may include an icon for “become ambassador.” 622.

After operation 602, the method 600 proceeds to operation 604 and the server 102 receives an ambassador selection. For example, with reference to FIG. 13, the user may select the “become ambassador” icon 622 and the selection is transmitted to the server 102.

With reference again to FIG. 12, once a user's ambassador selection is received, the method 600 may proceed to operation 606. In operation 606 the server 102 assesses whether the user is qualified to be ambassador. For example, the platform 100 may set certain restrictions as to who may be an ambassador. Restrictions may include that the user must live in the location, be a member in good standing (e.g., not have been reported for harassment in three months), have certain qualifications or backgrounds, or other standards. If a user is not qualified, method 600 proceeds to operation 608 and the server 102 transmits an ineligible notification to the user device and the method 600 then proceeds to an end state 616.

If a member is qualified to be an ambassador in operation 606, the method 600 proceeds to operation 610. In operation 610, the server 102 transmits an ambassador agreement or ambassador data that includes information about being an ambassador, any rules or standards for the ambassador, or the like. FIG. 14 illustrates an example of an ambassador agreement screen. As shown in FIG. 14, the ambassador agreement screen 630 includes a popup or ambassador display 640 that includes information about the ambassador program, as well as optionally a contract or other agreement for the user to consent to the terms.

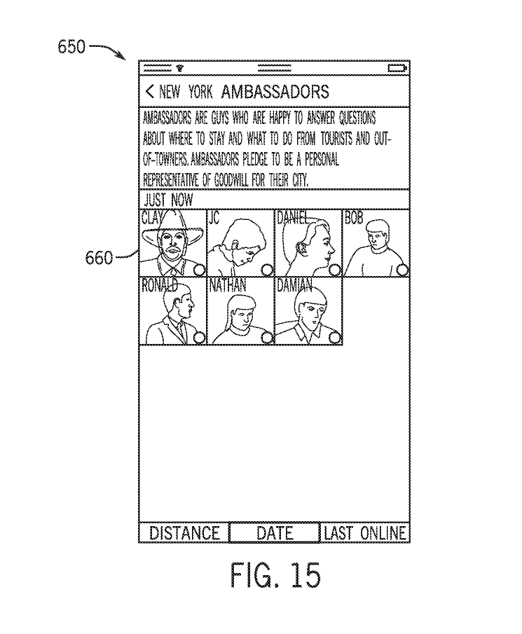

With reference again to FIG. 12, after transmission of the ambassador agreement, the method 600 may proceed to operation 612. In operation 612, the sever 102 determines whether the user has agreed to or consents to the ambassador program. For example, with reference to FIG. 14, the user may select the “continue” icon to agree to the ambassador program. If the user agrees to become an ambassador, the method 600 may proceed to operation 614 and the user may be added to the ambassador list for a particular location, i.e., enrolled as an ambassador. FIG. 15 illustrates an example list of ambassadors for a location. With reference to FIG. 15, ambassador users page 650 include a user icon 660 that is displayed on an ambassador page for a particular location.

With reference to FIG. 12, after the user has been added as an ambassador in operation 614 or if the user did not agree to the ambassador agreement, the method 600 proceeds to the end state 616. Using the method of FIG. 12, the travel platform 100 can generate a table of ambassadors for a particular location where the ambassadors can connect with users that are visiting or traveling to the particular location. This allows the ambassadors to provide valuable information such as “local's secrets” and other helpful information to users that are planning to visit.

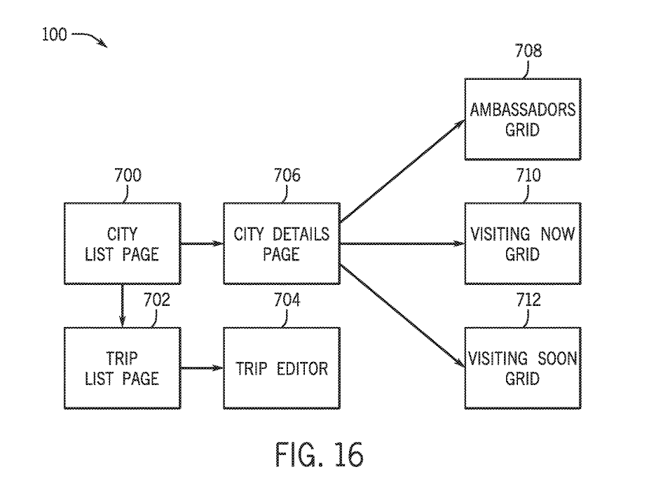

Using the methods 300, 400, 500, 600 the travel platform 100 can connect users with other users that they may find helpful in taking or planning their trip. In some embodiments the various methods can be integrated in a single platform. For example, FIG. 16 illustrates an example of a block diagram for the platform 100. With reference to FIG. 16, the platform 100 may display a location selection page 700, e.g., the location selection screen 320 of FIG. 4, when a user accesses a travel section of a parent application or in instances where the travel platform is a standalone application, when the user activates the application. From the city selection screen, the user may select his or her trip list page 702. The trip list page 702 may be similar to the travelogue screen 370 shown in FIG. 6 and include a list of all planned or automatically created trips for the user. From the trip list page 702 the user can view the details of his or her upcoming trips, as well as head to the trip editor page 704, which may pull up the trip itinerary screen 350 of FIG. 5. This allows a user to either edit a currently planned trip or to create a new trip.

With reference again to FIG. 16, from the city list page 700 or when a user selects a particular trip from the trip list page 702, the travel platform 100 may display a city details page 706. The city details page 706 may be similar to location details screen 520 of FIG. 9 and include an ambassadors grid 708, visiting now grid 710, and a visiting soon grid 712. Each of the grids include users and/or user data (e.g., profile pictures, names, etc.) of those users falling within the select category. For example, the ambassadors grid 708 includes the users that are ambassadors for the select location, such as the ambassadors page 650 of FIG. 15. These displays allow a user to select from the grid a user or multiple users that he or she may wish to communicate with to discuss a current trip or a future trip. In this manner the platform provides users with an easy and natural manner to connect with other travelers to arrange for tourist activities, select restaurants, hotels, activities, and the like, as well as receive advice from locals about great places to visit, stay, and other local tips.

### CONCLUSION

The foregoing description has broad application. For example, while examples disclosed herein may focus a social networking application, it should be appreciated that the concepts disclosed herein may equally apply to substantially any other member or user based interactive network, such as, video games, blogs, or the like. Similarly, although the controller may be discussed with respect to a server and smart phone, the devices and techniques disclosed herein are equally applicable to other types of computing devices. Accordingly, the discussion of any embodiment is meant only to be exemplary and is not intended to suggest that the scope of the disclosure, including the claims, is limited to these examples.

What is claimed is:

1. A method for matching users of a social media platform traveling in the same location comprising:
generating a travel database comprising a plurality of user travel data that corresponds to travel locations of a plurality of users;
receiving by a processing element new location information from a location module, the new location information corresponding to a current location of a first user device;
comparing by the processing element the new location information to historical information to determine if the new location is a travel location; and
when the new location is a travel location:
generating by the processing element a first user entry in the travel database in a memory component, the first user entry including first user travel data that corresponds to the first user indicating travel to the current location;
querying the travel database by the processing element to compare the first user travel data to one or more user travel data that corresponds to other users;
generating by the processing element a user match notification that corresponds to one or more users traveling in the current location; and
transmitting by the processing element the user match notification to the first user device.

2. The method of claim 1, wherein comparing by the processing element the new location to historical information comprises comparing a latitude and a longitude of a historical location to the new location information.

3. The method of claim 1, wherein the first user entry in the travel database comprises,
a destination field including a destination location corresponding to the new location information; and
a trip begin field including a date corresponding to a received data that the processing element received the new location information.

4. The method of claim 1, wherein the processing element generates a user match notification when a second user entry corresponding to a travel location matches the current location of the first user travel data.

5. The method of claim 4, wherein the processing element generates a user match notification if second user entry corresponding to the travel location matches the current location of the first user travel data and a second user entry corresponding to a trip purpose matches the first user entry corresponding to a trip purpose.

6. The method of claim 1, wherein the user match notification comprises transmitting one or more of the following to the first user device: a second user name, one or more travel dates of a second user traveling in the current location, or a travel purpose of the second user.

7. The method of claim 1, wherein the historical location comprises two or more previous locations of the first user device.

8. A system for matching users of a social media platform traveling in the same location comprising:
a first user device comprising a first location sensor, wherein the first location sensor determines location information of the first user device; and
a server in communication with the first user device, the server configured to:
generate a travel database comprising a plurality of user travel data that corresponds to travel locations of a the plurality of users based on location information from a plurality of user devices;
receive new location information from the first user device corresponding to a current of the first user device;
compare the new location information to historical location information of the first user device to determine if the new location is a travel location; and
when the new location is a travel location:
generate a first user entry in the travel database that corresponds to the first user indicating travel to the current location;
query the travel database to compare the first user travel data to one or more user travel data corresponding to other users;
generate a user match notification that corresponds to one or more users traveling in the current location; and
transmit the user match notification to the first user device.

9. The system of claim 8, wherein the historical location information comprises two or more previous locations of the first user device.

10. The system of claim 9, wherein the user match notification comprises user information corresponding to the one or more users traveling in the current location.

11. A system for connecting social media users visiting a destination comprising:
a first user device corresponding to a first user account, the first user device comprising:
a first location module that determines location information;
a first memory component that stores the location information, wherein the location information comprises new location data corresponding to a current location of the first user device and historical data corresponding to two or more previous locations of the first user device;
a first processor in communication with the first location module and the first memory component;
a first display in communication with the first processor; and
a server in communication with the first processor of the first user device, wherein the server performs the following operations:
receive new location data from the first processor;
compare the new location data to historical location data to determine if the current location is a travel location;
if the current location is a travel location, generate a first user travel entry in a travel database, wherein the first user travel entry comprises first user trip data;
dynamically matching the first user travel entry with a second user travel entry having similar characteristics to the first user travel entry; and
transmitting second user information to the first display.

12. The system of claim 11, wherein the first user travel entry comprises at least one of the following: a travel location corresponding to the current location, one or more travel dates, a first user name, a trip duration, or a trip purpose.

13. The system of claim 12, wherein the server dynamically matches the first user travel entry with the second user travel entry when the travel location of the first user entry matches a travel location of the second user entry and the one or more travel dates of the first user entry match the one or more travel dates of the second user entry.

14. The system of claim 11, wherein the new location data comprises a new latitude and a new longitude and the historical location data comprises a first historical latitude, a first historical longitude, a second historical latitude, and a second historical longitude.

15. The system of claim 14, wherein the current location is determined to be a travel location when
the new latitude is outside a predetermined distance of the first historical latitude and the second historical latitude; and
the new longitude is outside a predetermined distance of the first historical longitude and the second historical longitude.

16. The system of claim 11, wherein the first user travel entry comprises data input by the first user via the first user device.

17. The system of claim 11, wherein when the current location is a travel location, the server transmits ambassador data to the first user device corresponding to users living in the travel location that have agreed to provide travel information to traveling users.

18. The system of claim 17, wherein the server further
determines whether an requesting user is qualified to be an ambassador;
if the user is qualified, transmitting by the processing element an ambassador agreement to a requesting user device; and
upon receiving a consent to the ambassador agreement from the requesting user device, assigns the requesting user to an ambassador role for the travel location.
